(19) United States
(12) Patent Application Publication
(10) Pub. No.: US 2025/0212213 A1
(43) Pub. Date: Jun. 26, 2025

(54) UE CONFIGURED FOR DYNAMICALLY SCHEDULED PUCCH REPETITION WITH PUCCH RESOURCE INDICATION

(71) Applicant: Intel Corporation, Santa Clara, CA (US)

(72) Inventors: Gang Xiong, Beaverton, OR (US); Sergey Panteleev, Maynooth (IE); Bishwarup Mondal, San Ramon, CA (US); Sergey Sosnin, Zavolzhie (RU); Jie Zhu, San Jose, CA (US)

(21) Appl. No.: 19/076,469

(22) Filed: Mar. 11, 2025

Related U.S. Application Data
(63) Continuation of application No. 17/499,254, filed on Oct. 12, 2021, now abandoned.
(60) Provisional application No. 63/092,425, filed on Oct. 15, 2020.

(51) Int. Cl. H04W 72/1268; H04L 1/1812; H04L 5/00; H04W 52/24; H04W 72/0446; H04W 72/23

(52) U.S. Cl. CPC H04W 72/1268; H04L 1/1819; H04L 5/0053; H04W 52/242; H04W 72/0446; H04W 72/23

(57) ABSTRACT

A UE configured for operation in a 5G NR network may decode RRC signalling from a generation gNB that includes a PUCCH-Config IE to configure the UE with a number of slots for PUCCH repetition. The UE may decode a DCI format scheduling dynamic PUCCH repetition per PUCCH resource when the DCI format indicates a PUCCH resource for the PUCCH repetition. The PUCCH resource may include a repetition number of slot and may be indicated by the DCI format comprising a starting symbol index and a number of symbols for repetition of the PUCCH within each of the slots of the number of slots. If the DCI indicates the PUCCH resource that includes the repetition number of slots, the DCI format schedules dynamic PUCCH repetition and the UE repeats the scheduled PUCCH transmission in accordance with the repetition number of slots per the PUCCH resource indicated by the DCI format, otherwise, the UE repeats the scheduled PUCCH transmission in accordance with a repetition number indicated by the PUCCH-Config IE. Each repetition of the PUCCH may have the same first symbol corresponding to the starting symbol index in each slot and the same number of consecutive symbols in each slot corresponding to the number of symbols.

### PRIORITY CLAIM

This application is a continuation of U.S. patent application Ser. No. 17/499,254, filed Oct. 12, 2021, which claims the benefit of priority under 35 U.S.C. 119 (e) to U.S. Provisional Patent Application Ser. No. 63/092,425, filed Oct. 15, 2020, each of which is incorporated herein by reference in its entirety.

### TECHNICAL FIELD

Embodiments pertain to next generation wireless communications. In particular, some embodiments relate to physical uplink control channel (PUSCH) repetitions in 5G networks.

### BACKGROUND

The use and complexity of wireless systems, which include 5th generation (5G) networks and are starting to include sixth generation (6G) networks among others, has increased due to both an increase in the types of devices user equipment (UEs) using network resources as well as the amount of data and bandwidth being used by various applications, such as video streaming, operating on these UEs. With the vast increase in number and diversity of communication devices, the corresponding network environment, including routers, switches, bridges, gateways, firewalls, and load balancers, has become increasingly complicated. As expected, a number of issues abound with the advent of any new technology.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a PUCCH repetition pattern in accordance with some aspects.

FIG. 4 illustrates contiguous repetition for PUCCH coverage enhancement in accordance with some aspects.

FIG. 5 illustrates separate time domain resource allocation (TDRA) for each slot for PUCCH repetition in accordance with some aspects.

FIG. 6 illustrates cancellation of actual PUCCH repetition due to invalid PUCCH format in accordance with some aspects.

FIG. 7 illustrates cancellation of actual PUCCH repetition due to PUCCH format change in accordance with some aspects.

FIG. 8 illustrates change of PUCCH format for actual PUCCH repetition in accordance with some aspects.

FIG. 9 illustrates repetition of symbols from nominal PUCCH repetition in the first actual PUCCH repetition in accordance with some aspects.

FIG. 10 illustrates repetition of symbols from nominal PUCCH repetition in the first and second actual PUCCH repetitions in accordance with some aspects.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

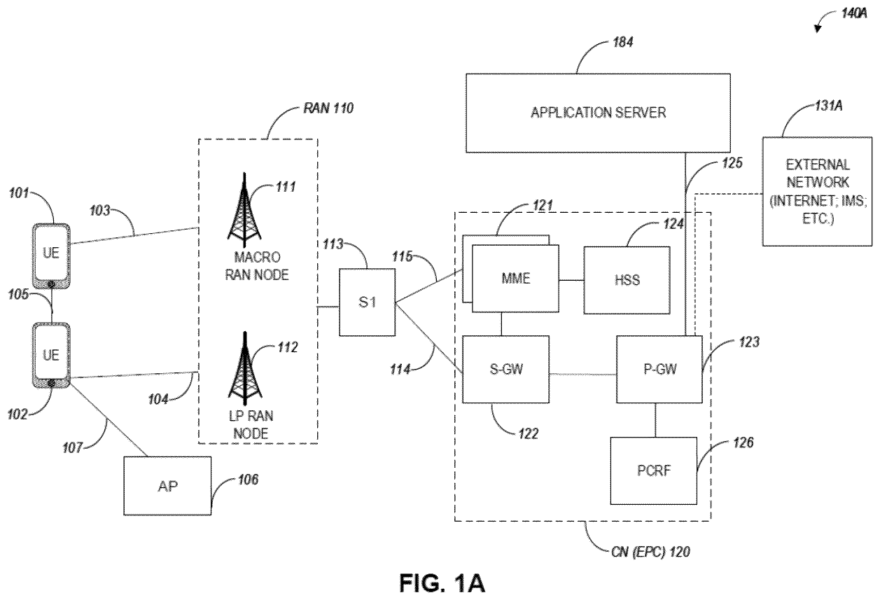

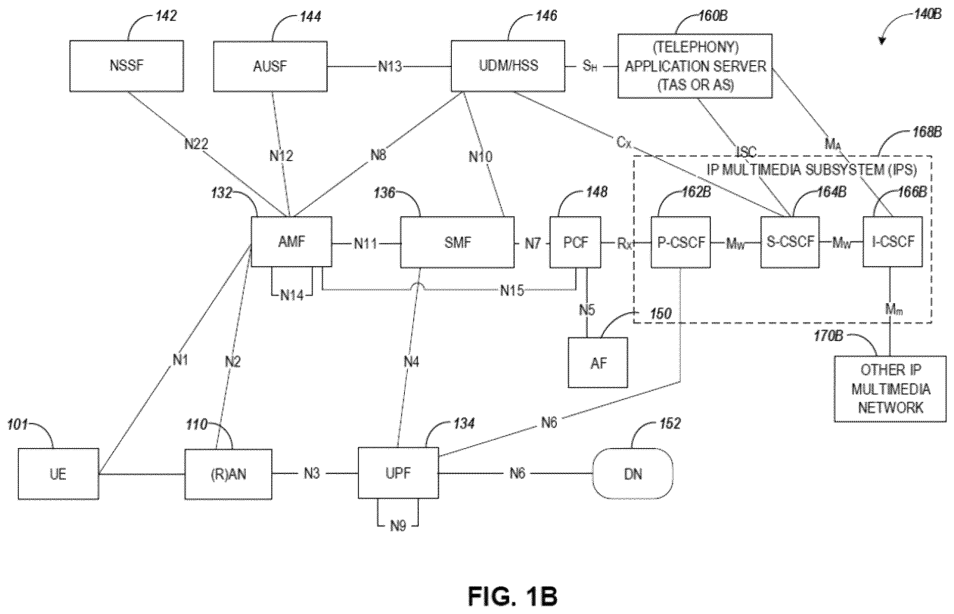

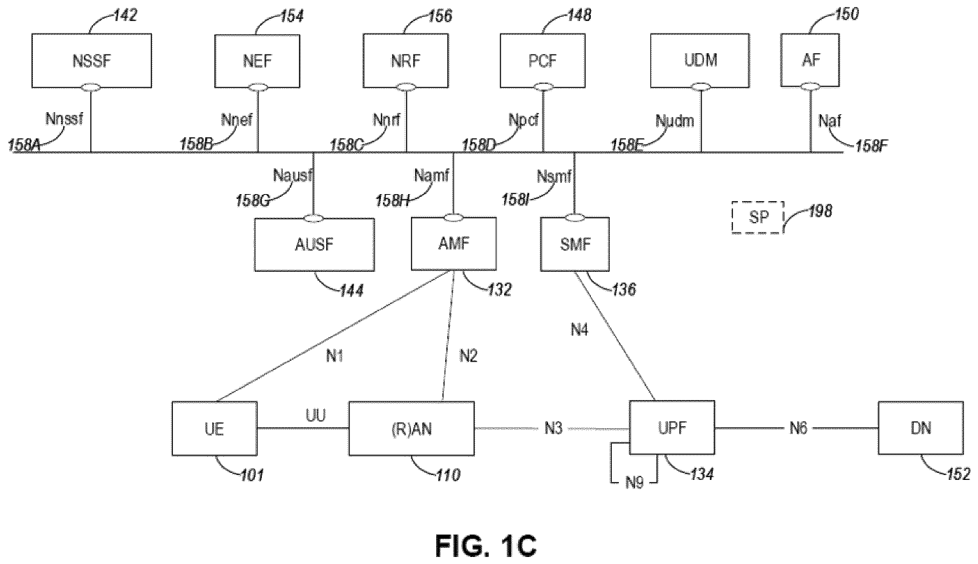

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170E, e.g. an IMS operated by a different network operator.

In some aspects, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

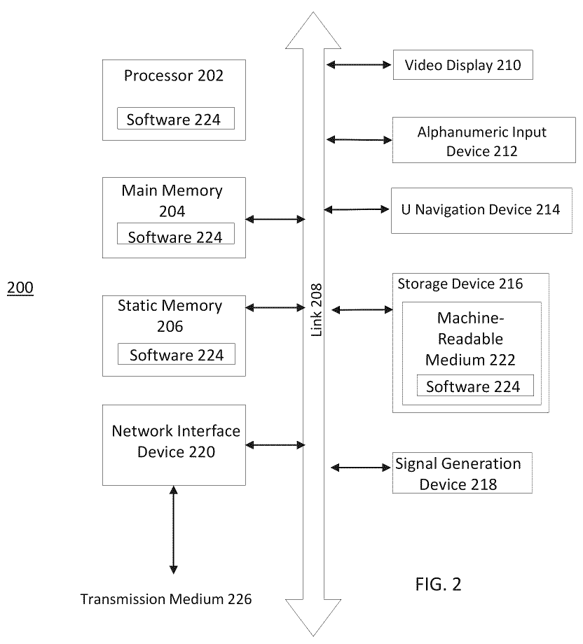

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5th generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHZ), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHZ, 1710-2025 MHz, 2110-2200 MHz, 2300-2400 MHZ, 2.4-2.4835 GHz (note: it is an ISM band with global availability and it is used by Wi-Fi technology family (11b/g/n/ax) and also by Bluetooth), 2500-2690 MHZ, 698-790 MHZ, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHZ, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHZ, 37-38.6 GHZ, 38.6-40 GHz, 42-42.5 GHZ, 57-64 GHZ, 71-76 GHZ, 81-86 GHz and 92-94 GHz, etc), the ITS (Intelligent Transport Systems) band of 5.9 GHZ (typically 5.85-5.925 GHz) and 63-64 GHZ, bands currently allocated to WiGig such as WiGig Band 1 (57.24-59.40 GHz), WiGig Band 2 (59.40-61.56 GHZ) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

Some of the features in this document are defined for the network side, such as APs, eNBs, NR or gNBs-note that this term is typically used in the context of 3GPP 5G and 6G communication systems, etc. Still, a UE may take this role as well and act as an AP, eNB, or gNB; that is some or all features defined for network equipment may be implemented by a UE.

As above, new radio (NR) is to provide access to information and sharing of data anywhere, anytime by various users and applications. NR is expected to be a unified network/system that target to meet vastly different and sometime conflicting performance dimensions and services. Such diverse multi-dimensional requirements are driven by different services and applications. In general, NR is to evolve based on 3GPP LTE-Advanced with additional potential new Radio Access Technologies (RATs) to enable everything connected by wireless and to deliver fast, rich contents and services.

For cellular systems, coverage is one factor for successful operation. Compared to LTE, NR can be deployed at relatively higher carrier frequency in frequency range 1 (FR1), e.g., at 3.5 GHz. In this case, a greater amount of coverage loss is expected due to larger path-loss, which makes it more challenging to maintain an adequate quality of service. Typically, uplink coverage is one bottleneck for system operation considering the low transmit power at the UE side.

In NR Rel-15, short physical uplink control channel (PUCCH) formats, PUCCH formats 0 and 2, can span 1 or 2 symbols and long PUCCH, PUCCH formats 1, 3 and 4, can span from 4 to 14 symbols within a slot. More specifically:

PUCCH format 0 can be used to carry up to 2 uplink control information (UCI) bits. PUCCH format 0 is designed based on a sequence selection mechanism in which the information bit is used to select a sequence to be transmitted. The sequence is a computer generated sequence (CGS) with length 12 and low peak-to-average power ratio (PAPR).

PUCCH format 1 can be used to carry up to 2 UCI bits. Further, one or two UCI bits are first modulated as binary phase-shift keying (BPSK) or quadrature phase-shift keying (QPSK) symbols and then multiplied by a CGS with length 12 and low PAPR.

PUCCH format 2 can be used to carry more than 2 UCI bits. PUCCH format 2 is based on an orthogonal frequency division multiplexing (OFDM) waveform, where a demodulation reference signal (DMRS) is interleaved with the UCI symbols within the allocated resource. The number of physical resource blocks (PRB) can be configured from 1 to 16.

PUCCH format 3 can be used to carry more than 2 UCI bits. PUCCH format 3 is based on a Direct Fourier Transform spread orthogonal frequency-division multiplexing (DFT-S-OFDM) waveform, where DMRS and UCI symbols are multiplexed in a time division multiplexing (TDM) manner.

PUCCH format 4 can be used to carry more than 2 UCI bits and spans 1 PRB in frequency. Further, a pre-discrete Fourier transform (DFT) blocked-wise sequence is applied on the modulated UCI symbols to allow multiple UEs to be multiplexed in the same PRB.

Note that UCI can be carried by the PUCCH. In particular, the UCI may include a scheduling request (SR), hybrid automatic repeat request-acknowledgement (HARQ-ACK) feedback, a channel state information (CSI) report, e.g., a channel quality indicator (CQI), a pre-coding matrix indicator (PMI), a CSI resource indicator (CRI) and a rank indicator (RI) and/or beam related information (e.g., layer 1-reference signal received power (L1-RSRP)).

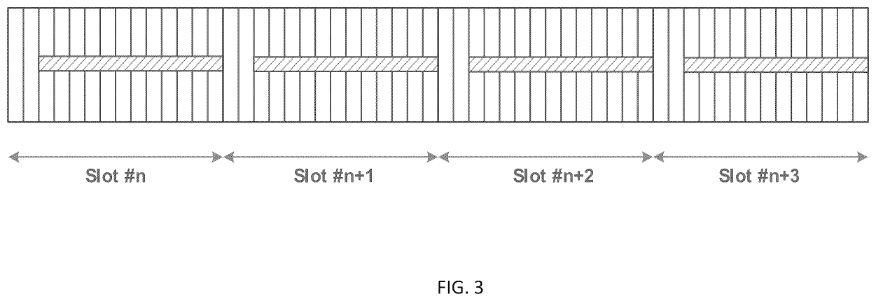

For a long PUCCH, i.e., PUCCH format 1, 3 and 4, a number of slots can be configured to further enhance the coverage. FIG. 3 illustrates a PUCCH repetition pattern in accordance with some aspects. As shown in FIG. 3, when repetition is employed, the same TDRA for the transmission of the PUCCH is used in each slot. Further, inter-slot frequency hopping can be configured to improve the performance by exploiting frequency diversity.

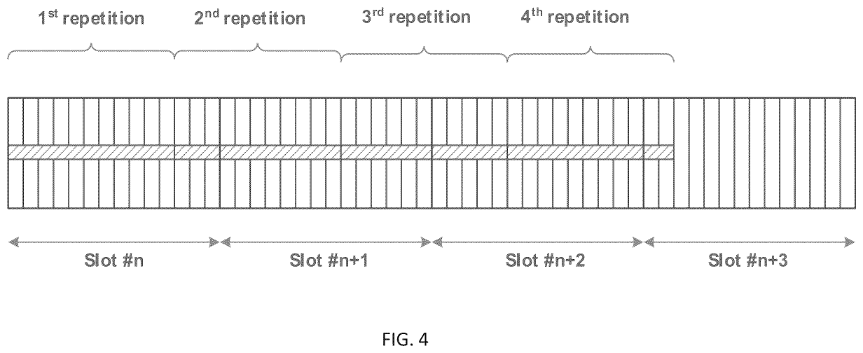

To further improve the PUCCH coverage, contiguous repetition may be considered for PUCCH, where a second repetition follows immediately after a first repetition, which can fill the gap between two PUCCH repetitions for a PUCCH repetition pattern as defined in Rel-15 and hence improve the coverage for PUCCH. FIG. 4 illustrates contiguous repetition for PUCCH coverage enhancement in accordance with some aspects. In FIG. 4, PUCCH repetitions are transmitted in a contiguous manner, which can help in reducing the latency for PUCCH repetition.

In order to support contiguous repetition for PUCCH coverage enhancement, several design aspects may be considered, which is similar to physical uplink shared channel (PUSCH) repetition type B as defined in Rel-16. This may include design aspects on how to handle the collision with semi-static downlink (DL) symbols, handle the case when the PUCCH repetition is across the slot boundary, etc. To this end, a resource allocation scheme is disclosed for an enhanced PUCCH repetition mechanism, as is a mechanism on handling collision with semi-static DL symbols and invalid symbols.

### Resource Allocation for Enhanced PUCCH Repetition Mechanism

Embodiments of resource allocation for enhanced PUCCH repetition mechanism are provided as follows:

In some embodiments, separate TDRA are configured for each slot or repetition for enhanced PUSCH repetition type for a PUCCH resource. In particular, starting symbols and number of symbols of a PUCCH repetition can be configured by higher layers via minimum system information (MSI), remaining minimum system information (RMSI), other system information (OSI) or dedicated radio resource control (RRC) signalling. This can help in maximizing flexibility on time domain resource allocation for PUCCH repetition.

In some embodiments, in addition to starting symbol and number of symbols a repetition factor may be used to indicate that the same starting symbol and number of symbols are repeated for a predetermined number of consecutive slots. As an example, a set of triplets may be used (starting symbol index, number of symbols, number of repetitions).

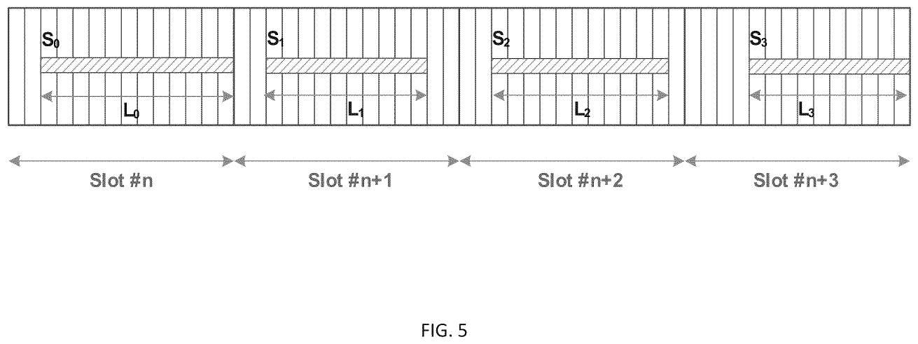

FIG. 5 illustrates separate TDRA for each slot for PUCCH repetition in accordance with some aspects. As shown, separate starting symbol S and length L in symbols for each slot during repetition may be configured by higher layers for a PUCCH resource.

In some embodiments, the starting symbol and number of symbols for one or more than one PUCCH repetition in a slot for a PUCCH resource can be configured by RRC signalling. Further, TDRA for one or more than one PUCCH repetitions are repeated in one slot (or more than one slots) for enhanced PUCCH repetition.

In some embodiments, the number of repetitions for PUCCH transmission can be configured by higher layers via RMSI (SIB1), OSI or RRC signalling. The number of repetitions can be configured per PUCCH resource, or per PUCCH resource set.

The following text in TS 38.331 can be updated to include the number of repetitions (nrofrep) for a PUCCH resource:

```
PUCCH-Resource ::=  SEQUENCE {
  pucch-ResourceId  PUCCH-ResourceId,
  startingPRB  PRB-Id,
  intraSlotFrequencyHopping  ENUMERATED { enabled }
OPTIONAL, -- Need R
secondHopPRB  PRB-Id  OPTIONAL, --
Need R
nrofrep  INTEGER (1, 2, 4, 8, 16)  OPTIONAL, --
Need R
  format  CHOICE {
    format0  PUCCH-format0,
    format1  PUCCH-format1,
    format2  PUCCH-fortnat2,
    format3  PUCCH-format3,
    format4  PUCCH-format4
  }
}
```

In another option, for a PUCCH carrying SR and CSI report, the number of repetitions can be configured by RRC signalling. The number of repetitions can be configured per PUCCH resource, or per PUCCH resource set. For a PUCCH carrying dynamic HARQ-ACK feedback, the number of repetitions can be configured by RRC signalling, or dynamically indicated in the DCI for scheduling physical downlink shared channel (PDSCH), or a combination thereof. In one example, a set of number of repetitions may be configured by RRC signalling, where one field in the DCI may be used or one or more existing fields in the DCI may be repurposed to indicate which one value from the set of number of repetitions is used for a PUCCH carrying HARQ-ACK feedback.

In some embodiments, for frequency domain resource allocation, both inter-slot and inter-repetition frequency hopping can be used for enhanced PUCCH repetition mechanism. Note that whether inter-slot frequency hopping or inter-repetition frequency hopping is applied for enhanced PUCCH repetition may be configured by higher layers via RRC signalling, or dynamically indicated in the DCI or a combination thereof. The type of hopping, if used, can also be configured for a PUCCH resource, or a PUCCH format or a PUCCH resource set.

Similar to existing PUCCH repetition mechanisms, intra-slot frequency hopping may also be configured. Further, for inter-repetition frequency hopping, the frequency hopping is applied per actual repetition or nominal repetition basis. Note that the starting PRB in the first and second hops is configured for a PUCCH resource.

In some embodiments, a UE may be configured with an enhanced PUCCH resource that contains multiple PUCCH resources, each of which has its own start symbol, length in symbols, frequency allocation starting PRB, and number of PRBs. The below illustrates an information RRC message that implements this embodiment, where the UE may be provided with a set of PUCCH-RepetitionResource configuration of number of up to maxPucchRep:

```
PUCCH-Resource-Enhanced ::=  SEQUENCE {
  pucch-ResourceId  PUCCH-ResourceId,
  pucch-ResourceAllocation  SEQUENCE (SIZE (1..maxPucchRep))
OF PUCCH-RepetitionResource
}
PUCCH-RepetitionResource ::  SEQUENCE {
  startingPRB  PRB-Id,
  intraSlotFrequencyHopping  ENUMERATED { enabled }
OPTIONAL, -- Need R
secondHopPRB  PRB-Id  OPTIONAL, --
Need R
  format  CHOICE {
    format0  PUCCH-format0,
    format1  PUCCH-format1,
    format2  PUCCH-format2,
    format3  PUCCH-format3,
    format4  PUCCH-format4
  }
}
```

### Enhanced PUCCH Repetition Mechanism for Multi-TRP

In some embodiments, each PUCCH repetition occasion can be associated with a distinct set of TRP parameters. A set of TRP parameters includes Quasi Co-Location (QCL) parameters, power control parameters, coding parameters. QCL parameters include a reference signal for QCL-Type D (beam information). Power control parameters include a reference signal for pathloss determination, and power control values Po (target power) and a (fractional pathloss parameter). Coding parameters include redundancy version.

Mechanism of Handling Collision with Semi-Static DL Symbols and Invalid Symbols

Embodiments for handling collisions with semi-static DL symbols and invalid symbols for the enhanced PUCCH repetition mechanism when contiguous PUCCH repetitions are performed back-to-back are provided as follows:

In some embodiments, when a PUCCH repetition crosses a slot boundary, the PUCCH repetition or nominal repetition is dropped.

In another option, a nominal PUCCH repetition is segmented into two actual repetitions. When the length of one actual PUCCH repetition is equal to 3 symbols, which is invalid for PUCCH formats, the actual PUCCH repetition may be cancelled. In addition, when the PUCCH format is changed from a long PUCCH format in nominal repetition to a short PUCCH format in actual repetition, the actual repetition is cancelled. In one example, when a long PUCCH format is used for nominal repetition and after segmentation, the number of symbols for actual repetition is reduced to 1 or 2 symbols, which results in a short PUCCH format, the actual repetition is dropped.

In another option, when the PUCCH format is changed from a long PUCCH format in nominal repetition to a short PUCCH format in actual repetition, the actual repetition is cancelled only for a UCI payload size greater than 2 bits. For a UCI payload size less than 3 bits, the actual repetition is still transmitted.

In one example, for a UCI payload size less than 3 bits, when PUCCH format 1 is used for nominal repetition and the number of symbols for actual repetition due to segmentation is reduced to 1 or 2 symbols, this results in PUCCH format 0 for actual repetition. In this case, actual repetition is still transmitted.

In another example, for a UCI payload size greater than 2 bits, when PUCCH format 3 is used for nominal repetition and the number of symbols for actual repetition due to segmentation is reduced to 1 or 2 symbols, this results in PUCCH format 2 for actual repetition. In this case, actual repetition is dropped.

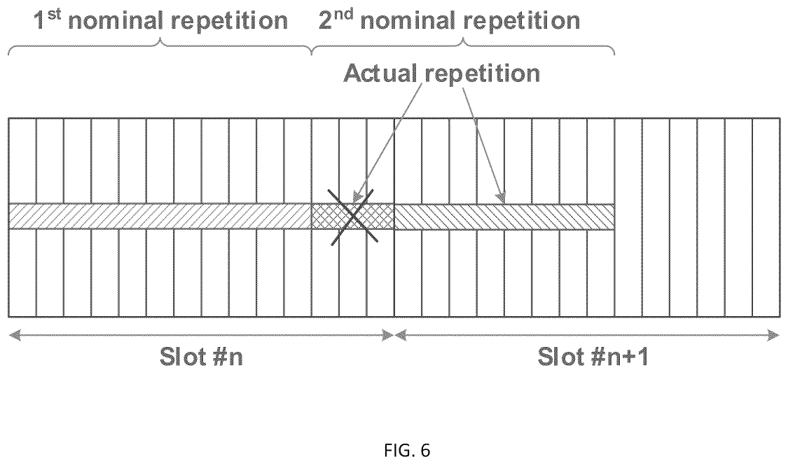

FIG. 6 illustrates cancellation of actual PUCCH repetition due to invalid PUCCH format in accordance with some aspects. In the example shown in FIG. 6, the starting symbol and length of the first repetition is symbol #0 and 11 symbols, respectively. As the 2nd nominal repetition is across the slot boundary, the 2nd nominal repetition is segmented into two actual repetitions. Given that the length of the 1st actual repetition of the 2nd nominal repetition is 3 symbols, which results in an invalid PUCCH format, the 1st actual repetition is cancelled.

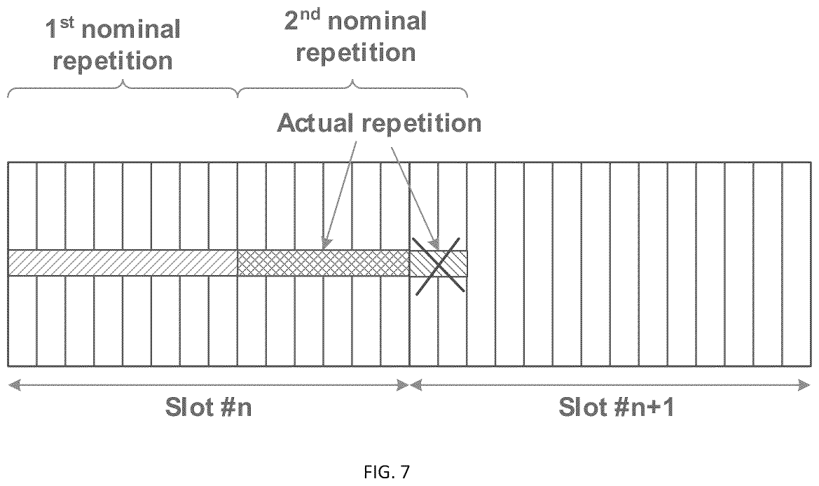

FIG. 7 illustrates cancellation of actual PUCCH repetition due to PUCCH format change in accordance with some aspects. In the example shown in FIG. 7, starting symbol and length of the first repetition is symbol #0 and 8 symbols, respectively. As the 2nd nominal repetition is across a slot boundary, the 2nd nominal repetition is segmented into two actual repetitions. Further, the duration of the 2nd actual repetition in the 2nd nominal repetition is 2 symbols, which indicates that a long PUCCH format or PUCCH format 3 for the 2nd actual repetition is changed to a short PUCCH format, or PUCCH format 2 for a UCI payload size of 10 bits. In this case, the actual repetition is dropped.

In another embodiment, when a PUCCH repetition is across a slot boundary, the PUCCH repetition is segmented into two actual repetitions. Further, when the PUCCH format is changed from a long PUCCH format in a nominal repetition to a short PUCCH format in an actual repetition, the actual repetition based on the short PUCCH format is still transmitted regardless of the UCI payload size. More specifically, if the UCI payload size is greater than 2 bits, the starting PRB of the actual repetition based on PUCCH format 2 may be same as that for the nominal repetition, but the number of PRBs can be derived based on the number of symbols for the actual repetition, the UCI payload size, the maximum code rate, and the modulation order based on the PUCCH format in the actual repetition. If the UCI payload size is less than or equal to 2 bits, the starting PRB of the PUCCH actual repetition based on PUCCH format 0, the same starting PRB and the number of PRBs, or 1 PRB are used for the actual PUCCH repetition and the nominal PUCCH repetition.

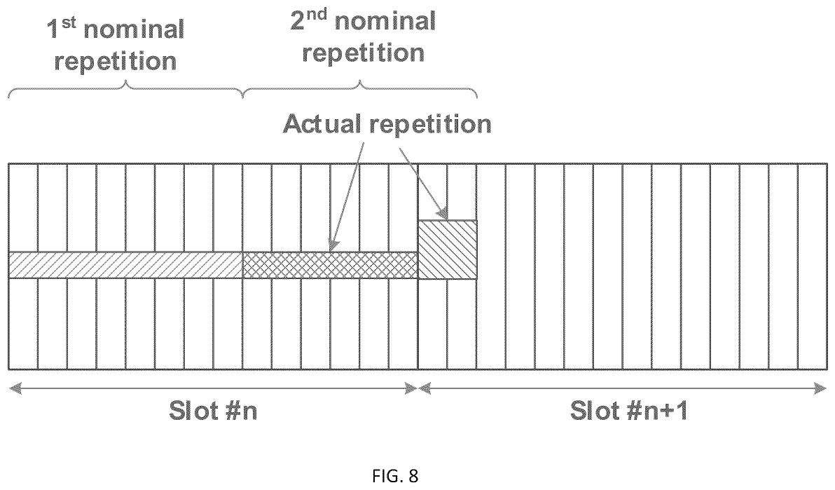

FIG. 8 illustrates change of PUCCH format for actual PUCCH repetition in accordance with some aspects. That is, FIG. 8 illustrates one example of PUCCH format change from a nominal repetition to an actual repetition. In the example shown in FIG. 8, the starting symbol and length of the first repetition is symbol #0 and 8 symbols, respectively. As the 2nd nominal repetition is across a slot boundary, the 2nd nominal repetition is segmented into two actual repetitions. Further, the duration of the 2nd actual repetition in the 2nd nominal repetition is 2 symbols, which indicates that a long PUCCH format for the 2nd actual repetition is changed to a short PUCCH format. When the UCI payload size is larger than 2 bits, PUCCH format 2 is used for the 2nd actual repetition. In this case, the same starting PRB is used for PUCCH format 2 and the number of PRBs is determined based on the UCI payload size, the maximum code rate, the modulation order, and the number of symbols for the PUCCH format in the actual repetition.

In another option, when the PUCCH format is changed from long PUCCH format in nominal repetition to short PUCCH format in actual repetition or when the number of symbols for actual repetition is 3 symbols, the actual PUCCH repetition is cancelled. Further, DMRS symbols for PUCCH transmission are inserted for the actual PUCCH repetition. DMRS sequence generation follows that the DMRS sequence generation for PUCCH format 3.

In another option, if the PUCCH format is same for nominal repetition and actual repetition, the same starting PRB is applied for the nominal repetition and the actual repetition. Further, for a UCI payload size greater than 2 bits, and PUCCH format 2, 3 and 4 for both the nominal and actual repetition, the number of PRBs for the actual repetition is same as that for the nominal repetition, which is derived based on the number of symbols for the nominal repetition, the UCI payload size, the maximum code rate, and the modulation order based on the PUCCH format in the nominal repetition.

For a UCI payload size less than 3 bits, and PUCCH format 0 and 1 for both the nominal and the actual repetition, the starting PRB and the number of PRBs (i.e., 1 PRB) for the actual repetition is same as that for the nominal repetition.

Note that the above mechanism can also apply for the case when a long PUCCH format in the nominal repetition is changed to a short PUCCH format in the actual repetition, i.e., the starting symbol and the number of PRBs for the actual repetition are same as that for the nominal repetition, wherein the number of PRBs is derived based on the number of symbols for the nominal repetition, the maximum code rate, the UCI payload size, and the modulation order for the PUCCH format in the nominal repetition.

In another embodiment, when a PUCCH repetition is across a slot boundary, the PUCCH repetition is segmented into two actual repetitions. Further, each actual PUCCH repetition contains UCI symbols from the nominal repetition or part of the UCI symbols from the nominal repetition are repeated and transmitted in each actual repetition. In this case, the encoding and rate matching procedure for the actual repetitions is repeated for the nominal repetition and part of symbols are used for transmission in each actual repetition.

As a further extension, a threshold may be defined for the ratio between the length of the actual repetition and the nominal repetition. Further, the threshold may be configured by higher layers via MSI, RMSI (SIB1), OSI or RRC signalling. When the ratio between the length of the actual repetition and the nominal repetition is less than the threshold, the actual repetition is dropped. Otherwise, part of the UCI symbols in the actual repetition are repeated from the nominal repetition and transmitted.

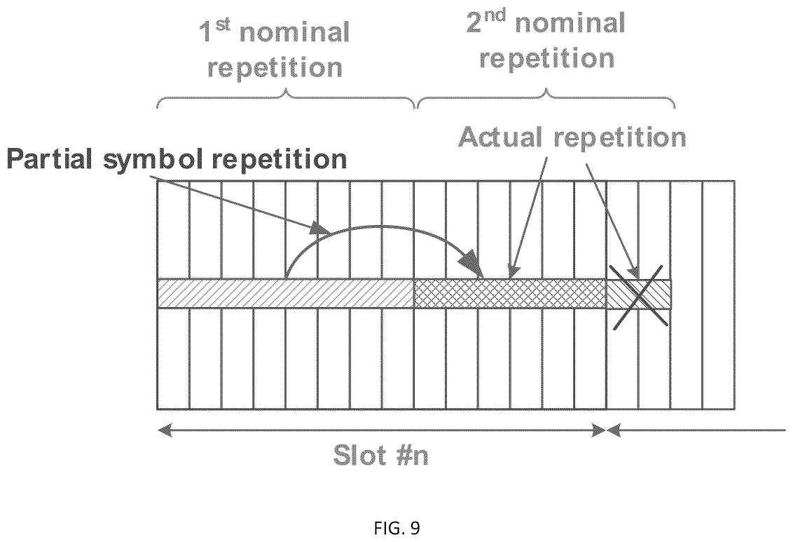

FIG. 9 illustrates repetition of symbols from nominal PUCCH repetition in the first actual PUCCH repetition in accordance with some aspects. That is, FIG. 9 illustrates one example of repeating part of the UCI symbols for the actual repetition. In the example, the nominal PUCCH repetition has a length of 8 symbols with 2 symbols dedicated for DMRS transmission and 6 symbols dedicated for UCI payload transmission. Further, the second PUCCH actual repetition is canceled, and the first actual PUCCH repetition includes 2 DMRS symbols and 4 UCI payload symbols, which repeat the part of the UCI symbols from the 1st nominal repetition. For example, the first 4 symbols containing the UCI payload are transmitted in the first actual PUCCH repetition.

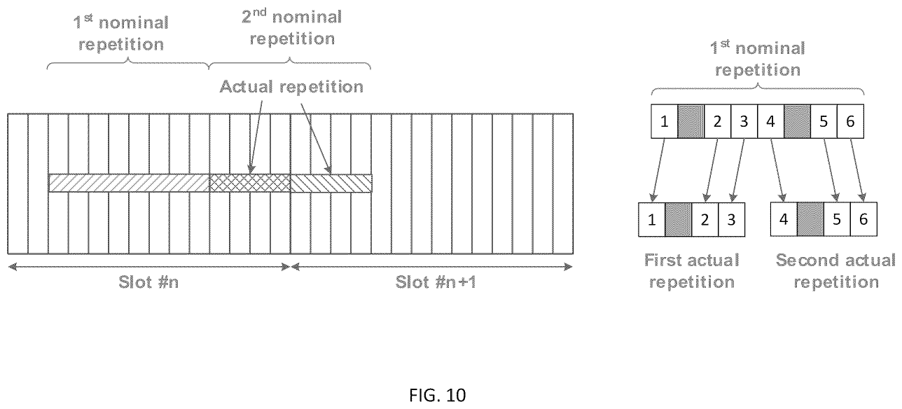

In another option, the nominal symbol selection procedure can be used along with permutation to transmit different symbols in each actual repetition. FIG. 10 illustrates repetition of symbols from nominal PUCCH repetition in the first and second actual PUCCH repetitions in accordance with some aspects. FIG. 10 illustrates one example of two actual repetitions including the same number of symbols dedicated for the UCI transmission, where different UCI symbols in the nominal repetition are transmitted in each actual repetition.

In another embodiment, when a nominal PUCCH repetition collides with invalid symbols, the nominal PUCCH repetition is dropped or segmented into multiple actual repetitions, where each actual repetition consists of a consecutive set of all potentially valid symbols. The invalid symbols include semi-static DL symbols and flexible DL symbols, such as Synchronization Signal Block (SSB) and CORESET0 configured by the master information block (MIB)). The invalid symbols may be configured by RRC signalling or dynamically indicated in the DCI (or a combination thereof). The aforementioned options, that is when a nominal repetition is across a slot boundary, can also be applied when the nominal PUCCH repetition collides with invalid symbols.

The procedure for determining invalid symbols for a new PUCCH repetition mechanism or a PUCCH repetition type B and mechanisms on segmentation from a nominal repetition is described as follows:

For PUCCH repetition Type B, the UE determines invalid symbol(s) for PUCCH repetition Type B transmission as follows:

A symbol that is indicated as downlink by tdd-UL-DL-ConfigurationCommon or tdd-UL-DL-ConfigurationDedicated is considered as an invalid symbol for PUCCH repetition Type B transmission.

For operation in unpaired spectrum, symbols indicated by ssb-PositionsInBurst in SIB1 or ssb-PositionsInBurst in ServingCellConfigCommon for reception of SS/PBCH blocks are considered as invalid symbols for PUCCH repetition Type B transmission.

For operation in unpaired spectrum, one or more symbol(s) indicated by pdcch-ConfigSIB1 in the MIB for a CORESET for Type0-PDCCH CSS set are considered as invalid symbol(s) for PUCCH repetition Type B transmission.

For operation in unpaired spectrum, if numberInvalidSymbolsForDL-UL-Switching is configured, numberInvalidSymbolsForDL-UL-Switching symbol(s) after the last symbol that is indicated as downlink in each consecutive set of all symbols that are indicated as downlink by tdd-UL-DL-ConfigurationCommon or tdd-UL-DL-ConfigurationDedicated are considered as invalid symbol(s) for PUCCH repetition Type B transmission. The symbol(s) given by numberInvalidSymbolsForDL-UL-Switching are defined using the reference SCS configuration referenceSubcarrierSpacing provided in tdd-UL-DL-ConfigurationCommon.

For PUCCH repetition Type B, after determining the invalid symbol(s) for PUCCH repetition type B transmission for each of the K nominal repetitions, the remaining symbols are considered as potentially valid symbols for a PUCCH repetition Type B transmission. If the number of potentially valid symbols for a PUCCH repetition type B transmission is greater than zero for a nominal repetition, the nominal repetition includes one or more actual repetitions, where each actual repetition has a consecutive set of all potentially valid symbols that can be used for a PUCCH repetition Type B transmission within a slot. An actual repetition with a single symbol is omitted except for the case of L=3. An actual repetition is omitted according to the conditions in Clause 11.1 of [6, TS 38.213].

In another embodiment, invalid symbols for a PUCCH repetition can be configured by higher layers via MSI, RMSI (SIB1), OSI or RRC signalling. In one option, InvalidSymbolPattern for PUSCH repetition type B may be reused for the enhanced PUCCH repetition mechanism. In another option, an invalid symbol pattern can be separately configured by MSI, RMSI (SIB1), OSI or RRC signalling for an enhanced PUCCH repetition type. If not configured, InvalidSymbolPattern for PUSCH repetition type B may be used for the enhanced PUCCH repetition type.

Note that the invalid symbol pattern for the enhanced PUCCH repetition type can be configured similar to the InvalidSymbolPattern for PUSCH repetition type B. In particular, a time domain pattern in symbol level in one or two slots can be configured with a predetermined configured periodicity.

The configuration of invalid symbol pattern for enhanced PUCCH repetition type can be given as:

The UE may be configured with the higher layer parameter InvalidSymbolPatternPUCCH, which provides a symbol level bitmap spanning one or two slots (higher layer parameter symbols given by InvalidSymbolPatternPUCCH). A bit value equal to 1 in the symbol level bitmap symbols indicates that the corresponding symbol is an invalid symbol for PUCCH repetition Type B transmission. The UE may be additionally configured with a time-domain pattern (higher layer parameter periodicityAndPattern given by InvalidSymbolPatternPUCCH), where each bit of periodicityAndPattern corresponds to a unit equal to a duration of the symbol level bitmap symbols, and a bit value equal to 1 indicates that the symbol level bitmap symbols is present in the unit. The periodicityAndPattern can be {1, 2, 4, 5, 8, 10, 20 or 40} units long, but maximum of 40 ms. The first symbol of periodicityAndPattern every 40 ms/P periods is a first symbol in frame n_{f} mod 4=0, where P is the duration of periodicityAndPattern in units of ms. When periodicityAndPattern is not configured, for a symbol level bitmap spanning two slots, the bits of the first and second slots correspond respectively to even and odd slots of a radio frame, and for a symbol level bitmap spanning one slot, the bits of the slot correspond to every slot of a radio frame.

For PUCCH carrying HARQ-ACK feedback, when InvalidSymbolPattern is configured, one field in the DCI format scheduling PDSCH may be used to or some field in the DCI may be repurposed indicate whether the InvalidSymbolPattern is enabled, i.e., the UE applies the invalid symbol pattern when transmitting PUCCH repetition. This field may be configured whether it is present or not in the DCI format, which may be configured per DCI format, e.g., DCI format 1_1 or 1_2.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for a user equipment (UE) configured for operation in a 5th Generation New Radio (5G NR) network, the apparatus comprising: processing circuitry; and memory, the processing circuitry configured to:
decode radio resource control (RRC) signalling from a generation NodeB (gNB) that includes a physical uplink control channel (PUCCH) configuration information element (PUCCH-Config IE) to configure the UE with a number of slots for PUCCH repetition;
decode a downlink control information (DCI) format received from the gNB scheduling a PUCCH transmission, the DCI format scheduling dynamic PUCCH repetition per PUCCH resource when the DCI format indicates a PUCCH resource for the PUCCH repetition, the PUCCH resource including a repetition number of slots,
the PUCCH resource indicated by the DCI format comprising a starting symbol index and a number of symbols for a repetition of the PUCCH within each of the slots of the number of slots; and
encode the PUCCH for transmission to the gNB,
if the DCI indicates the PUCCH resource that includes the repetition number of slots, the DCI format schedules dynamic PUCCH repetition and the processing circuitry repeats the scheduled PUCCH transmission in accordance with the repetition number of slots per the PUCCH resource indicated by the DCI format, otherwise, the processing circuitry repeats the scheduled PUCCH transmission in accordance with a repetition number indicated by the PUCCH-Config IE,
wherein for dynamic PUCCH repetition, each repetition of the PUCCH has a same first symbol corresponding to the starting symbol index in each slot and a same number of consecutive symbols in each slot corresponding to the number of symbols,
wherein the memory is configured to store the PUCCH-Config IE.

2. The apparatus of claim 1, wherein the PUCCH-Config IE further includes a PUCCH format field indicating which PUCCH format of a plurality of PUCCH formats that specific PUCCH parameters for the PUCCH repetition apply to.

3. The apparatus of claim 1, wherein the PUCCH-Config IE further includes UE specific PUCCH parameters including a starting physical resource block (PRB), a second hop PRB and an indication of whether inter-slot frequency hopping or intra-slot frequency hopping is enabled.

4. The apparatus of claim 3, wherein when the inter-slot frequency hopping is enabled, the processing circuitry is configured transmit repetitions of the PUCCH in alternating slots using the starting PRB and the second hop PRB.

5. The apparatus of claim 3, wherein when the inter-slot frequency hopping is enabled, the processing circuitry is configured transmit the PUCCH in even numbered slots based on the starting PRB and transmit the PUCCH in odd numbered slots based on the second hop PRB.

6. The apparatus of claim 1, wherein the processing circuitry is configured to:
determine whether one or more repetitions of the PUCCH will cross a slot boundary when transmitted; and
refrain from transmitting the one or more of the repetitions that are determined to cross a slot boundary.

7. The apparatus of claim 1, wherein the processing circuitry is configured to include a same uplink control information (UCI) with each repetition of the PUCCH.

8. The apparatus of claim 1, wherein the PUCCH is repeated in each of a plurality of contiguous slots of the number of slots using the PUCCH resource.

9. The apparatus of claim 1, wherein the PUCCH-Config IE further includes first and second sets of power control parameters for first and second repetitions of the PUCCH, respectively.

10. The apparatus of claim 9, wherein the power control parameters include an indicator of a reference signal for pathloss determination.

11. A non-transitory computer-readable storage medium that stores instructions for execution by processing circuitry of a user equipment (UE) configured for operation in a 5th Generation New Radio (5G NR) network, the processing circuitry configured to:
decode radio resource control (RRC) signalling from a generation NodeB (gNB) that includes a physical uplink control channel (PUCCH) configuration information element (PUCCH-Config IE) to configure the UE with a number of slots for PUCCH repetition;
decode a downlink control information (DCI) format received from the gNB scheduling a PUCCH transmission, the DCI format scheduling dynamic PUCCH repetition per PUCCH resource when the DCI format indicates a PUCCH resource for the PUCCH repetition, the PUCCH resource including a repetition number of slots,
the PUCCH resource indicated by the DCI format comprising a starting symbol index and a number of symbols for a repetition of the PUCCH within each of the slots of the number of slots; and
encode the PUCCH for transmission to the gNB,
if the DCI indicates the PUCCH resource that includes the repetition number of slots, the DCI format schedules dynamic PUCCH repetition and the processing circuitry repeats the scheduled PUCCH transmission in accordance with the repetition number of slots per the PUCCH resource indicated by the DCI format, otherwise, the processing circuitry repeats the scheduled PUCCH transmission in accordance with a repetition number indicated by the PUCCH-Config IE,
wherein for dynamic PUCCH repetition, each repetition of the PUCCH has a same first symbol corresponding to the starting symbol index in each slot and a same number of consecutive symbols in each slot corresponding to the number of symbols.

12. The non-transitory computer-readable storage medium of claim 11, wherein the PUCCH-Config IE further includes a PUCCH format field indicating which PUCCH format of a plurality of PUCCH formats that specific PUCCH parameters for the PUCCH repetition apply to.

13. The non-transitory computer-readable storage medium of claim 11, wherein the PUCCH-Config IE further includes UE specific PUCCH parameters including a starting physical resource block (PRB), a second hop PRB and an indication of whether inter-slot frequency hopping or intra-slot frequency hopping is enabled.

14. The non-transitory computer-readable storage medium of claim 13, wherein when the inter-slot frequency hopping is enabled, the processing circuitry is configured transmit repetitions of the PUCCH in alternating slots using the starting PRB and the second hop PRB.

15. The non-transitory computer-readable storage medium of claim 13, wherein when the inter-slot frequency hopping is enabled, the processing circuitry is configured transmit the PUCCH in even numbered slots based on the starting PRB and transmit the PUCCH in odd numbered slots based on the second hop PRB.

16. The non-transitory computer-readable storage medium of claim 11, wherein the processing circuitry is configured to:
determine whether one or more repetitions of the PUCCH will cross a slot boundary when transmitted; and
refrain from transmitting the one or more of the repetitions that are determined to cross a slot boundary.

17. The non-transitory computer-readable storage medium of claim 11, wherein the processing circuitry is configured to include a same uplink control information (UCI) with each repetition of the PUCCH.

18. A user equipment (UE) configured for operation in a 5th Generation New Radio (5G NR) network, the UE comprising: processing circuitry; and memory, the processing circuitry configured to:
decode radio resource control (RRC) signalling from a generation NodeB (gNB) that includes a physical uplink control channel (PUCCH) configuration information element (PUCCH-Config IE) to configure the UE with a number of slots for PUCCH repetition;
decode a downlink control information (DCI) format received from the gNB scheduling a PUCCH transmission, the DCI format scheduling dynamic PUCCH repetition per PUCCH resource when the DCI format indicates a PUCCH resource for the PUCCH repetition, the PUCCH resource including a repetition number of slots,
the PUCCH resource indicated by the DCI format comprising a starting symbol index and a number of symbols for a repetition of the PUCCH within each of the slots of the number of slots; and
encode the PUCCH for transmission to the gNB,
if the DCI indicates the PUCCH resource that includes the repetition number of slots, the DCI format schedules dynamic PUCCH repetition and the processing circuitry repeats the scheduled PUCCH transmission in accordance with the repetition number of slots per the PUCCH resource indicated by the DCI format, otherwise, the processing circuitry repeats the scheduled PUCCH transmission in accordance with a repetition number indicated by the PUCCH-Config IE,
wherein for dynamic PUCCH repetition, each repetition of the PUCCH has a same first symbol corresponding to the starting symbol index in each slot and a same number of consecutive symbols in each slot corresponding to the number of symbols.

19. The UE of claim 18, wherein the PUCCH-Config IE further includes a PUCCH format field indicating which PUCCH format of a plurality of PUCCH formats that specific PUCCH parameters for the PUCCH repetition apply to, and wherein the PUCCH-Config IE further includes UE specific PUCCH parameters including a starting physical resource block (PRB), a second hop PRB and an indication of whether inter-slot frequency hopping or intra-slot frequency hopping is enabled.

20. The UE of claim 18, further comprising one or more antennas configured for transmission of the PUCCH, and
wherein the memory is configured to store the PUCCH-Config IE.
